(19) United States
(12) Patent Application Publication
(10) Pub. No.: US 2002/0112547 A1
(43) Pub. Date: Aug. 22, 2002

(54) Tactile probe

(76) Inventors: Mohamed Elsayed Hossney Eltaib, Dundee (GB); James Robert Hewit, Fife (GB)

Correspondence Address: MYERS BIGEL SIBLEY & SAJOVEC, PO BOX 37428, RALEIGH, NC, 27627, US

(21) Appl. No.: 09/990,892

(22) Filed: Nov. 16, 2001

Related U.S. Application Data
(60) Provisional application No. 60/252,781, filed on Nov. 22, 2000.

(51) Int. Cl. G01N 3/32

(52) U.S. Cl. 73/808

(57) ABSTRACT

A probe for detecting tactile properties of objects is described, and in particular for detecting properties of tissue during surgery. The probe 30 comprises a pressure sensor 10 mounted on a reciprocally movable rigid rod 32, and may be connected to a data processor such as a personal computer. In use, an operator applies the sensor 10 to a tissue to be examined, and the rod 32 is reciprocated. The output from the sensor 10 may be transferred to a personal computer, and compared with reference data from a healthy tissue sample. The comparison allows abnormal tissue to be detected in a relatively non-invasive manner.

A corresponding method is also described.

### CROSS-REFERENCE TO RELATED APPLICATIONS

This application claims priority from U.S. Provisional Patent Application No. 60/252,781, filed on Nov. 22, 2000, the disclosure of which is incorporated by reference herein in its entirety.

### FIELD OF THE INVENTION

The present invention relates to a probe for detection of tactile properties of objects. In particular, but not exclusively, the invention relates to such a probe for use in detection of tactile properties of human or animal tissue during surgery. The invention further relates to a method of detection of tactile properties of an object; in particular of tissue during surgery.

### BACKGROUND OF THE INVENTION

An important tool in a surgeon's armoury of diagnostic techniques is touch. Palpation of a tissue or organ can allow determination of the condition of the tissue or organ under consideration, and in particular may permit detection and localisation of growths or other areas of abnormal density, resilience, or lumpiness.

There is however a growing trend for minimal access surgery, or ‘keyhole’ surgery. That is, the surgeon performs the necessary surgical procedures using long, slender instruments which are passed into the body through small access wounds. While this has undoubted benefits to the patient, in that the invasiveness of such procedures is much reduced, the surgeon is unable to access the site of surgery directly. Thus, they are unable to use their own hands and fingers to touch the tissue under consideration, and assess the condition of the patient. The surgeon is therefore put at a disadvantage, and loses one of his or her important tools for surgery.

A number of proposals have been made to allow some restoration of tactile sense to a surgeon during keyhole surgery. The best known are probably those which are based on sensing the static force applied to the tissue and the corresponding tissue deformation or deflection. By this means the stiffness can be quantified. Bicchi, et al. (1996), used this approach to identify elastic properties of different objects. This principle is used in commercial instruments (laparoscopic pliers) modified to sense force by strain gauges and position by LEDs and optical detectors.

Another approach has been proposed by Cohn, et al. (1995). This involves a capacitive tactile sensor to detect the varying dielectric permittivity of different tissue types. It is suggested that fat, blood vessels and cancerous tissue might all be discriminated by this means.

Howe, et al. (1995), have investigated the remote palpation technique for surgical applications. A tactile array sensor in the remote tip of an instrument or probe measures the distribution of pressure across the tissue contact. The resulting signal is displayed using a tactile display device mounted in the finger tip contact area of the surgeon's interface.

Omata and Terunuma (1992) used a different approach for stiffness detection, which involves the use of a piezoelectric ceramic as a transducer. This is caused to vibrate at its resonant frequency. When the free end of the probe touches a material, the resonant frequency shifts due to acoustic impedance. The shift in resonant frequency depends on the stiffness of the material. Miyaji, et al. (1997), used the same sensor as Omata for measuring the stiffness of the lymph nodes accurately. They concluded that measurement of the stiffness of resected lymph nodes was confirmed as an accurate approach to diagnosing lymph node metastases without knowledge of other factors, such as lymph node size or color.

Brett and Stone (1997) have investigated new methods for obtaining force and tactile information. Their approach is to determine a distribution of contact force using a small number of sensory elements distributed across the surface of a finger (of known bending behaviour). The bending of the finger surface is used to assess the contact forces. The output of the sensor elements, contacting soft tissue, in conjunction with the behaviour of the finger surface are used to compute surface shape using a special algorithm or a neural network.

### SUMMARY OF THE INVENTION

According to a first aspect of the present invention, there is provided a method of detecting tactile properties of an object, the method comprising the steps of:

placing a sensor in contact with an object;

reciprocating the sensor to apply force to the object;

detecting output signals generated by the sensor; and

analysing the output to determine tactile properties of the object.

Thus, the present method allows a force to be applied to an object which will vary with reciprocation of the sensor. The sensor, typically a touch or pressure sensor, will provide an output which reflects the pressure experienced by the sensor due to the object, which pressure will vary both as the applied force varies and as the rigidity, deformation, density, and other properties of the object vary. Use of a reciprocal movement of the sensor and/or controllable indentation rate allows the effect of involuntary movements of the sensor due for example to random movements of the user's hand to be compensated for. Thus, the present method allows a more reliable assessment of tactile properties to be made with a hand-held instrument. Further, by varying the frequency of reciprocation, it is possible to elicit a richer set of dynamic characteristics than could be obtained using a static measurement system.

Preferably the object is human or animal tissue.

Preferably the step of reciprocating the sensor comprises the step of applying substantially sinusoidal movement to the sensor.

Preferably the method further comprises the step of moving the sensor across the object to detect output signals obtained from different areas of the object. Conveniently the analysis step may involve comparing signals obtained from different areas of the object; this allows determination of the relative tactile properties of parts of the object, so allowing relatively straightforward identification of areas of abnormal properties. The analysis step may alternatively or in addition comprise the step of comparing detected signals with reference signals obtained from objects of known tactile properties; for example, a tissue which is known to be healthy. The output signal may be displayed graphically to a user, who may then interpret the output visually; or the signal may be provided by means of a tactile output device, for example an array of controllable pins, rods or the like to simulate the properties of the object under study. The pins or rods may be moved, or provided with resistance to movement, in response to output signals to simulate the properties of the object. Other suitable output display means will be readily apparent to the person of skill in the art.

Preferably the method further comprises the step of applying a band pass filter to the output signals. This provides a convenient means of filtering out variations in signal caused by random movement of the probe, for example by the shaking of a user's hand.

According to a second aspect of the present invention, there is provided a tactile probe comprising a sensor, means for reciprocally moving the sensor, and processing means for detecting and processing signals from the sensor.

Preferably the sensor, typically a touch or pressure sensor, is a capacitance sensor.

Preferably the means for reciprocally moving the sensor comprises means for sinusoidally moving the sensor. The movement means may comprise an electric motor. Preferably the motor is a rotary motor, and is provided in combination with cam means for converting rotary motion to reciprocal motion. The cam means may conveniently be an eccentric cam. Alternatively, the motor may be a linear motor.

Preferably the sensor is mounted on a rigid rod or the like. This allows the sensor to access a tissue through a minimal access wound in a body.

Preferably the processing means comprises a data processing device; for example, a personal computer. The processing means may include a signal processing filter, such as a band pass filter.

The apparatus may further comprise a data output device; for example, a visual display, a tactile display, an audio output device, or the like.

The apparatus may yet further comprise a surgical tool. For example, the apparatus may include a scalpel, laser knife, or the like. This allows the surgeon to use the sensor to determine the location of an abnormality in a tissue, and then to remove the abnormality with the same apparatus.

### BRIEF DESCRIPTION OF THE DRAWINGS

These and other aspects of the present invention will now be described by way of example only and without limitation and with reference to the accompanying drawings, in which:

FIG. 1 is a pressure sensor module as may be used with an apparatus according to the present invention;

FIG. 2 is a tactile probe in accordance with the present invention;

FIG. 3 is a box diagram of the output processing arrangements of the present invention;

FIG. 4 shows an experimental set up using the probe of the present invention;

FIGS. 5 and 6 show experimental results obtained using the apparatus of FIG. 4; and

FIG. 7 shows experimental results obtained using a hand-held version of the inventive apparatus.

### DETAILED DESCRIPTION OF THE DRAWINGS

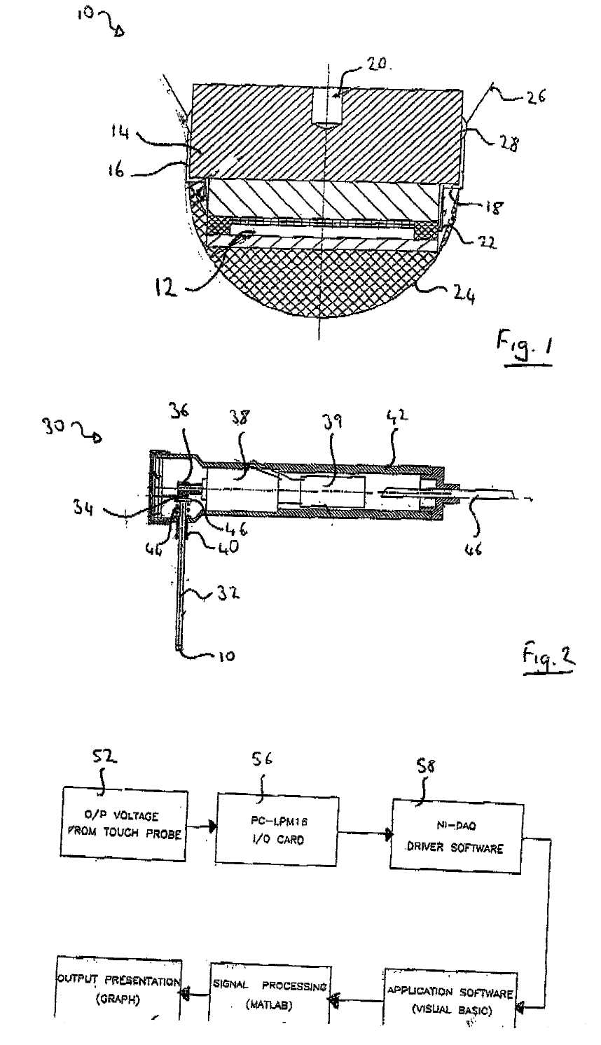

Referring first of all to FIG. 1, this shows a pressure sensor module as may be used in the probe of the present invention. The sensor module 10 comprises a micro-machined capacitive pressure sensor 12 (manufactured by Applied Microengineering Limited, of Abingdon, United Kingdom), supported on a cylindrical base 14 containing two conductive paths 16 to connect the gold flying wires 18. The base 14 also houses a small hole 20 to attach the sensor module 10 to the probe. A layer of epoxy 22 covers the gold wires 18 and the conductive paths 16, for protection. A dome of silicon rubber 24 covers the pressure sensor 12. The connecting wires 26 are bonded to the conductive paths using a conductive epoxy 28.

The probe itself, designated by numeral 30, is shown in FIG. 2. The sensor module 10 is mounted at one end of a sinusoidally reciprocal rigid rod 32, the other end having a hemispherical moulding 34 which abuts a cam mechanism comprising an offset cam 36, the cam 36 being rotatable by a DC electric motor 38 powered by battery 39. The rod 32 is held within a sleeve 40 formed in a moulded plastic body 42, and supported by a compression spring 44 and lip 46. The output signal from the sensor module 10 is passed upward along the rigid rod 32, through the body 42 of the probe 30, and to a PC along output cable 46.

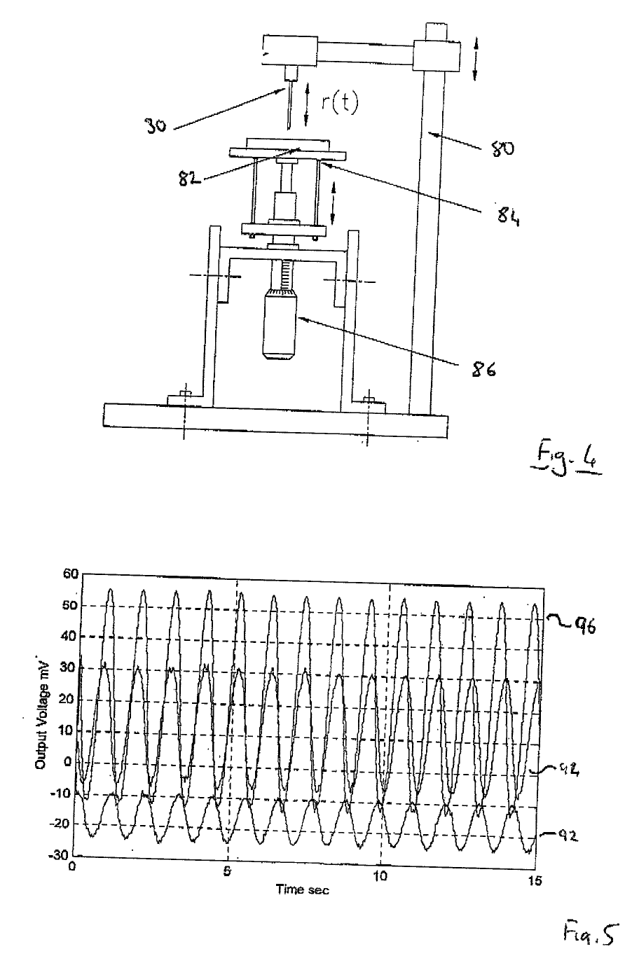

The arrangement of the probe 30 and signal processing arrangements are shown schematically in FIG. 3. To use the probe 30 the sensor module 10 is pressed lightly onto the surface of the tissue to be examined. The sinusoidal displacement causes a sinusoidal force to be applied to the pressure sensor. The force experienced by the sensor causes a change in capacitance. The capacitance is measured and converted to a voltage using a CSEM2003 chip (52). The output voltage is fed to a computer via a PC-LPM16 I/O card (56) (manufactured by National Instruments Ltd) for future signal conditioning. Special purpose software (57, 58) has been developed to drive the probe and to display real-time data in graphical form (62) to be processed via commercial MATLAB software (60); the particular software used is however not essential to performance of the invention, and the skilled person will readily be able to produce other suitable software, or to acquire off-the-shelf proprietary software.

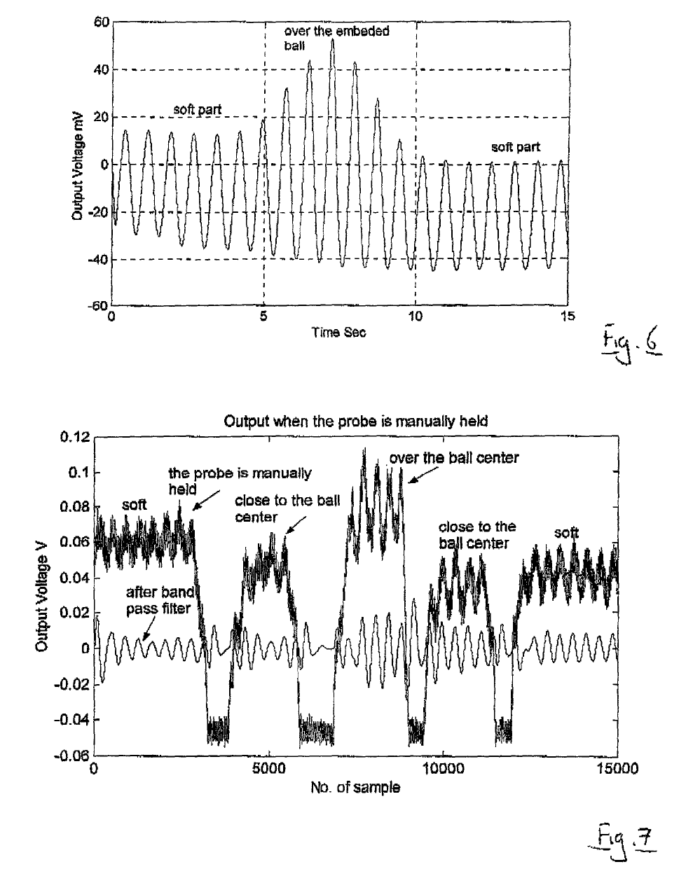

In order to evaluate the actual tactile probe performance in tissue condition assessment, a number of experiments were carried out. The experimental apparatus used is shown in FIG. 4; while FIGS. 5 to 7 show results from the experiments.

The aim of the first experiment was to investigate the probe performance when used in the assessment of homogeneous tissue. Three specimens were prepared from gelatine with consistencies similar to soft biological tissue. The ratios of gelatine concentration were 2:3:4. This produced a material of increasing stiffness. The specimens were cast in a Petri dish (51 mm diameter, 13 mm height). After the solutions were completely cured, the specimens were ready for testing.

The tactile probe 30 as described above was mounted to a stand 80 and made to probe the different gelatine specimens. The specimens 82 were mounted on a stage 84 as shown in FIG. 4. The stage 84 was moved vertically by means of a micrometer head assembly 86 until the surface of the specimen 82 touched the probe 30. The output of the probe then represents the initial contact force. Sinusoidal motion of the probe 30 was then started, indenting the gelatine specimen. The output was recorded and displayed and saved for further manipulations. The results of this experiment are presented in FIG. 5.

It is clear that the sensor was able to discriminate between the three specimens. The output voltage when the first specimen was tested was about 15 mV (peak to peak) (reference numeral 92 on FIG. 5), 40 mV (peak to peak) when testing the second specimen (numeral 94) and 65 mV (peak to peak) when testing the third specimen (numeral 96). The large amplitude represents the low compliance (that is, most stiff) and the low amplitude represents the high compliance (least stiff) specimen.

A second experiment was undertaken to simulate the detection of an abnormality in otherwise homogeneous tissue. Here a gelatine specimen with the same constitution as in the second specimen of the first experiment but with diameter 65 mm and 17 mm high was used. A stiff lump (a 7 mm-diameter ball of Blu-Tak (TM)) was embedded within the gelatine during casting at a depth of 5 mm. Readings were taken across the surface of the specimen, at points when the probe touched the soft part ofthe specimen and at points when the probe was above the centre of the embedded ball. The results are shown in FIG. 6. It is clear that the probe is easily able to detect the presence of the abnormality.

In a third experiment the probe was held manually as it would be in application to minimal access surgery. The probe was pressed into the same specimen used in the second experiment above, that is a sample with an embedded lump. In this case the output was band pass filtered to cancel the vibrations due to the human operator as well as to reduce noise. FIG. 7 illustrates the results from this experiment. A distinct difference can be detected between the soft part of the sample and that part over the embedded lump.

It can be seen from the foregoing, then, that the present invention provides a tactile probe which is able to detect tactile properties of tissue samples, and to identify the presence of areas of abnormal properties. The probe is also able to compensate for irregular vibrations introduced by an operator. Although the invention has been described primarily with reference to detection of tissue properties during surgery, it will be readily apparent to the skilled reader that the uses of the invention are not limited thereto. For example, a probe in accordance with the invention may be used in the food industry, for testing the condition foodstuffs such as soft fruit, baked goods, and the like. The probe may also be used for quality control of machinery parts such as gaskets and seals, where the compliance of such parts is important. The probe may be used as a hand held device, or may be mounted on machinery or robots, to assist in automated inspection of soft parts.

### References

Bicchi, A., G. Canepa, D. De Rossi, P. Iacconi and E. P. Scillingo(1996). A sensorized minimally invasive surgery tool for detecting tissue elastic properties. Proc. IEEE Int. Conf. on Robotics and Automation. Minneapolis, USA, pp. 884-888.

Brett, P. N. and R. S. W. Stone (1997). A technique for measuring contact force distribution in minimally invasive surgical procedures. Proc. Inst. Mech. Engrs, Part H, 211, 4,309-316.

Cohn, M. B., L. S. Crawford, J. M. Wendlant, and S. S. Sastry (1995). Surgical applications of milli robots. Journal of robotic systems 12,6,401-416.

Howe, R. D., W. J. Peine, D. A. Kontarinis and J. S. Son(1995). Remote palpation technology for surgical applications. IEEE Engineering in Medicine and Biology Magazine, 14,3, 318-323.

Miyaji, K., A. Furuse, J. Nakajima, Y. Koneko, T. Ohtsuka, K. Yagyu, T. Oka and S. Omata (1997). The stiffness of lymph nodes containing lung carcinoma metastases. Cancer, 80,10, 1920-1925.

Omata, S. and Y. Terunuma(1992). New tactile sensor like the human hand and its applications. Sensors and Actuators, A-Physics, 35, 1, 9-15

What is claimed is:

1. Method of detecting tactile properties of an object, the method comprising the steps of:
placing a sensor in contact with an object;
reciprocating the sensor to apply force to the object;
detecting output signals generated by the sensor; and
analysing the output signals to determine tactile properties of the object.

2. The method of claim 1, wherein the sensor is a touch sensor.

3. The method of claim 1, wherein the sensor is a pressure sensor.

4. The method of claim 1, further comprising the step of varying a frequency of reciprocation of the sensor while detecting output signals generated by the sensor.

5. The method of claim 1, wherein the object is human tissue.

6. The method of claim 1, wherein the object is animal tissue.

7. The method of claim 1, wherein the step of reciprocating the sensor comprises the step of applying substantially sinusoidal movement to the sensor.

8. The method of claim 1, further comprising the step of moving the sensor a cross the object to detect output signals obtained from different areas of the object.

9. The method of claim 1, wherein the analysis step comprises comparing signals obtained from different areas of the object.

10. The method of claim 9, further comprising determination of relative tactile properties of parts of the object, to identify abnormal areas of the object.

11. The method of claim 1, wherein the analysis step comprises the step of comparing detected signals with reference signals obtained from objects of known tactile properties.

12. The method of claim 11, wherein the reference signals are obtained from healthy tissue.

13. The method of claim 1, further comprising the step of displaying the output signals graphically to a user.

14. The method of claim 1, further comprising the step of representing the output signals to a user by means of a tactile output device.

15. The method of claim 14, wherein the tactile output device comprises an array of controllable pins.

16. The method of claim 14, wherein the tactile output device comprises an array of controllable rods.

17. The method of claim 1, further comprising the step of applying a band pass filter to the output signals.

18. A tactile probe comprising a sensor, means for reciprocally moving the sensor, and processing means for detecting and processing signals from the sensor.

19. The probe of claim 18, wherein the sensor is a touch sensor.

20. The probe of claim 18, wherein the sensor is a pressure sensor.

21. The probe of claim 18, wherein the sensor is a capacitance sensor.

22. The probe of claim 18, wherein the means for reciprocally moving the sensor comprises means for sinusoidally moving the sensor.

23. The probe of claim 18, wherein the movement means comprises an electric motor.

24. The probe of claim 23, wherein the motor is a rotary motor.

25. The probe of claim 24, wherein the rotary motor is provided in combination with cam means for converting rotary motion to reciprocal motion.

26. The probe of claim 25, wherein the cam means is an eccentric cam.

27. The probe of claim 23, wherein the motor is a linear motor.

28. The probe of claim 18, wherein the sensor is mounted on a rigid rod.

29. The probe of claim 18, wherein the processing means comprises a data processing device.

30. The probe of claim 18, wherein the processing means comprises a personal computer.

31. The probe of claim 18, wherein the processing means includes a signal processing filter.

32. The probe of claim 31, wherein the signal processing filter is a band pass filter.

33. The probe of claim 18, further comprising a data output device.

34. The probe of claim 33, wherein the data output device comprises a visual display.

35. The probe of claim 33, wherein the data output device comprises a tactile display.

36. The probe of claim 33, wherein the data output device comprises an audio output device.

37. The probe of claim 18, further comprising a surgical tool.

38. The probe of claim 37, wherein the tool comprises a scalpel.

39. The probe of claim 37, wherein the tool comprises a laser knife.
